(19) United States
(12) Patent Application Publication
(10) Pub. No.: US 2020/0242753 A1
(43) Pub. Date: Jul. 30, 2020

(54) WELDING QUALITY INSPECTION METHOD AND WELDING QUALITY INSPECTION DEVICE

(71) Applicant: TOYOTA JIDOSHA KABUSHIKI KAISHA, Toyota-shi (JP)

(72) Inventors: Yoshinori SHIBATA, Nagoya-shi (JP); Hiroomi KOBAYASHI, Okazaki-shi (JP)

(21) Appl. No.: 16/746,091

(22) Filed: Jan. 17, 2020

(30) Foreign Application Priority Data
Jan. 29, 2019 (JP) 2019-013620

(51) Int. Cl. G06T 7/00; B23K 26/03

(52) U.S. Cl. CPC G06T 7/0004; B23K 2103/18; B23K 26/032

(57) ABSTRACT

A method for welding quality inspection proposed herein includes a step of obtaining a surface image including a welded portion in which a first metal member and a second metal member are welded, and a step of obtaining, based on the surface image, a ratio of an area of an intermetal compound of the first metal member and the second metal member in an image area including at least the welded portion.

### CROSS REFERENCE OF RELATED APPLICATION

The present application claims priority from Japanese Patent Application No. 2019-013620 filed on Jan. 29, 2019, which is incorporated by reference herein in its entirety.

### BACKGROUND

The present disclosure relates to a welding quality inspection method and a welding quality inspection device.

In JP 2018-012125 A, it is proposed that, for a welding metal member including a first member and a second member stacked on the first member and made of a different material from a material of the first member and having a welded portion that passes through the second member and reaches the first member, a ratio of an intermetallic compound including a metal of the first member and a metal of the second member in the welded portion is set to 15% or more and 60% or less. In JP 2018-012125 A, it is disclosed that, for dissimilar metal welding, a welding spot is peeled off and element analysis is performed thereon, thereby obtaining the ratio of the intermetallic compound.

Specifically, for welding of aluminum and copper, element analysis of aluminum and copper is performed on a peeling surface after peeling by an electron probe microanalyzer (EPMA) without touching the peeling portion, and an element MAP is created for each of aluminum and copper. SEM images are also taken at the same angle. According to the SEM images, the peeing portion (the welded portion) is uneven, and therefore, a boundary of the welded portion is traced, a welding range is set, and an area of this portion is calculated. In the element MAP of aluminum and copper, correction is performed to eliminate noise such that a total composition of aluminum and copper in each point in the welded portion is 100%, the element MAP of aluminum is calculated again in three ranges, that is, composition regions of 0% to 25%, 26% to 75%, and 76% to 100%, and each of calculation results is displayed in binary representation. It is disclosed in JP 2018-012125 A to calculate a total area of the intermetallic compound, that is, a white portion of 26% to 75% and divide the total area by a welding area to calculate an area ratio (ratio), or the like.

### SUMMARY

The present inventor considers that, for welding quality inspection for dissimilar metals, it is desired to perform nondestructive inspection.

An embodiment of a welding quality inspection method proposed herein includes an assembling step, a welding step, a step of obtaining a surface image, and a step of obtaining a ratio of an area of an intermetal compound.

In the assembling step, a first metal member and a second metal member made of a different metal material from a metal material of the first metal member are made to at least partially overlap each other. In the welding step, a portion in which the first metal member and the second metal member are made to overlap each other is welded by irradiating the first metal member with laser to form a welded portion that passes through the first metal member and reaches the second metal member. In the step of obtaining a surface image, a surface image of the portion in which the first metal member and the second metal member are welded is obtained. In the step of obtaining a ratio of an area of an intermetal compound, a ratio of an area of an intermetal compound of the first metal member and the second metal member in an image area including at least the welded portion is obtained based on the surface image.

The ratio of the area of the intermetal compound has a correlation with a size of the intermetal compound in the welded portion and can be used as an index for evaluating quality of welding. According to the above described welding quality inspection method, for example, all of welded spots of inspection target objects can be inspected without destructing welded spots of the inspection target objects.

In the step of obtaining a ratio of an area of an intermetal compound, for example, the ratio of the area of the intermetal compound of the first metal member and the second metal member in the welded portion may be obtained.

As an example, the first metal member is made of copper or a copper alloy and the second metal member is made of aluminum or an aluminum alloy.

The welding quality inspection method may further include an evaluation step of determining, for example, when the ratio of the area of the intermetal compound is lower than a threshold set in advance, that quality of the welded portion is good.

Herein, the first metal member may be a current collector terminal of a battery, which is made of copper or a copper alloy, and the second metal member may be an external terminal of the battery, which is made of aluminum or an aluminum alloy. For example, in the assembling step, the current collector terminal of the battery, which is made of copper or a copper alloy, and the external terminal of the battery, which is made of aluminum or an aluminum alloy are assembled so as to at least partially overlap each other. In this case, in the welding step, a portion in which the current collector terminal and the external terminal are made to overlap each other may be welded by irradiating the current collector terminal with laser to form a welded portion that passes through the current collector terminal and reaches the external terminal. In the step of obtaining a surface image, a surface image including the welded portion in which the current collector terminal and the external terminal are welded may be obtained. In the step of obtaining a ratio of an area of an intermetal compound, a ratio of an area of an intermetal compound of copper or a copper alloy and aluminum or an aluminum alloy in the surface image may be obtained.

In the step of obtaining a ratio of an area of an intermetal compound, the ratio of the area of the intermetal compound of copper or a copper alloy and aluminum or an aluminum alloy in the welded portion may be obtained based on the surface image.

The above described welding quality inspection method can be incorporated as a step in a method for producing a battery.

A welding quality inspection device may include a camera, an image processing section, and a determination processing section. In this case, the camera may be configured to obtain a surface image of an inspection target object in which a first metal member and a second metal member made of a different metal material from a metal material of the first metal member are welded, the surface image including a welded portion in which the first metal member and the second metal member are welded. The image processing section may be configured to obtain, for example, based on the surface image including the welded portion, which has been taken by the camera, a ratio of an area of an intermetal compound of the first metal member and the second metal member in an image area including at least the welded portion. The determination processing section may be configured to determine, when the ratio of the area of the intermetal compound is lower than a threshold set in advance, that quality of the welded portion is good. According to the above described welding quality inspection device, quality of welding can be determined based on the surface image including the welded portion. Therefore, for example, all of welding spots of inspection target objects can be inspected without destructing the welded spots.

The image processing section may include a first processing module and a second processing module. Herein, the first processing module may be configured to define an image area including the welded portion and having an area set in advance in the surface image. The second processing module may be configured to extract the intermetal compound of the first metal member and the second metal member in the image area. In this case, the image processing section may be configured to obtain the ratio of the area of the intermetal compound extracted by the second processing module in the image area defined by the first processing module.

The first processing module may be configured to extract the welded portion in the surface image. In this case, the image processing section may be configured to obtain the ratio of the area of the intermetal compound extracted by the second processing module in the welded portion extracted by the first processing module.

A welding quality inspection device may include, for example, a camera configured to obtain, for an inspection target object in which a current collector terminal of a battery, which is made of copper or a copper alloy, and an external terminal of the battery, which is made of aluminum or an aluminum alloy, are welded, a surface image including a welded portion in which the current collector terminal and the external terminal are welded. In this case, an image processing section may be configured to obtain, based on the surface image including the welded portion, which has been taken by the camera, a ratio of an area of an intermetal compound of the copper or the copper alloy and the aluminum or the aluminum alloy in an image area including at least the welded portion. A determination processing section may be configured to determine, when the ratio of the intermetal compound is lower than a threshold set in advance, that quality of the welded portion is good.

The image processing section may include a first processing module and a second processing module. The first processing module may be configured to, for example, extract an image area including the welded portion and having an area set in advance in the surface image. The second processing module may be configured to extract the intermetal compound of the copper or the copper alloy and the aluminum or the aluminum alloy in the surface area. In this case, the image processing section may be configured to obtain a ratio of an area of the intermetal compound extracted by the second module in the image area extracted by the first module.

The first processing module may be configured to extract the welded portion in the surface image. In this case, the image processing section may be configured to obtain a ratio of an area of the intermetal compound extracted by the second module in the welded portion extracted by the first processing module.

### BRIEF DESCRIPTION OF THE DRAWINGS

FIG. 1 is a partial cross-sectional view of a battery to which an inspection method proposed herein is applied.

FIG. 2 is a plan view schematically illustrating a spot to be welded in a welding step.

FIG. 3 is a view illustrating a surface image obtained in a step of obtaining a surface image.

FIG. 4 is a view illustrating an image obtained by extracting an intermetallic compound W1 from a surface image including a welded portion W.

FIG. 5 is a view illustrating processing of an image processing section 221 in an embodiment.

FIG. 6 is a view illustrating processing of the image processing section 221 in another embodiment.

FIG. 7 is a graph illustrating a relationship between a ratio of an area of the intermetallic compound and peeling strength (tensile stress) of the welded portion of an internal terminal 12 and an external terminal 13.

### DETAILED DESCRIPTION

Hereinbelow, embodiments of a welding quality inspection method and a welding quality inspection device disclosed herein will be described. As a matter of course, the embodiments described herein are not intended to be particularly limiting the present invention. The present invention is not limited to the embodiment described herein, unless specifically stated otherwise.

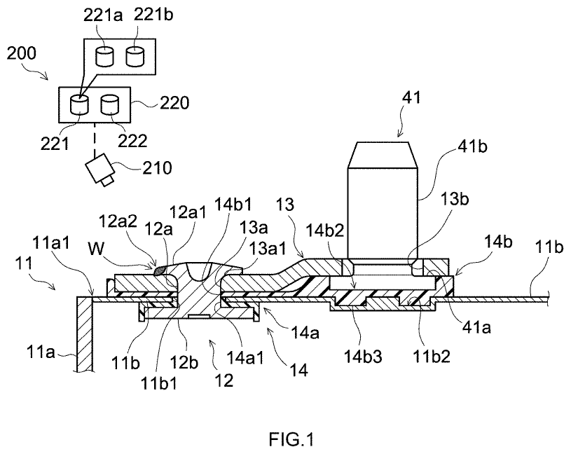

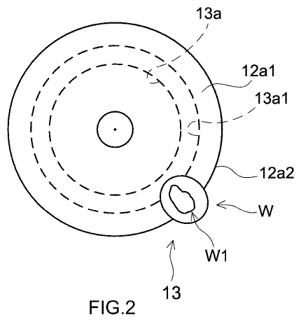

FIG. 1 is a partial cross-sectional view of a battery to which an inspection method proposed herein is applied. FIG. 2 is a plan view schematically illustrating a spot to be welded in a welding step.

For example, as illustrated in FIG. 1 and FIG. 2, a welding quality inspection method proposed herein can be used as a method for inspecting quality of welding in welding of an internal terminal 12 serving as a current collector terminal of a battery and an external terminal 13. The welding quality inspection method proposed herein and a welding quality inspection device 200 that embodies the welding quality inspection method will be described using welding of the internal terminal 12 and the external terminal 13 of the battery as an example herein. Note that embodiments of an application example of the welding quality inspection method and the welding quality inspection device 200 will be descried herein. However, the present disclosure is not limited to the embodiments described herein.

As illustrated in FIG. 1, the battery includes a lid 11b as a battery case component, the internal terminal 12, the external terminal 13, and a first insulation member 14a and a second insulation member 14b as an insulation member 14, and a connection terminal 41.

<Battery Case Component>

In this embodiment, a battery case component to be prepared is the lid 11b that is attached to an opening 11a1 of a case body 11a of a battery case 11, as illustrated in FIG. 1 and FIG. 2. The lid 11b is a plate-shaped member having a desired thickness and includes an attachment hole 11b1. The attachment hole 11b1 is a hole in which the internal terminal 12 and the external terminal 13 are attached. Note that the lid 11b is illustrated as a battery case component, but the battery case component is not limited to the lid 11b. The battery case component may be a component including the attachment hole 11b1 to which the internal terminal 12 and the external terminal 13 are attached, among components that form the battery case 11. In this embodiment, a cavity 11b2 used for attaching the second insulation member 14b is provided in an outer surface of the lid 11b. The cavity 11b2 is provided in accordance with a position in which the connection terminal 41 is attached.

<Internal Terminal 12>

The internal terminal 12 includes a shaft 12a that is inserted through the attachment hole 11b1. In this embodiment, the internal terminal 12 has a base portion 12b that is attached to an inner side of the lid 11b as a battery case component. The shaft 12a is provided in the base portion 12b. The shaft 12a may be inserted through the attachment hole 11b1 of the lid 11b and may have a desired length. Note that, although not illustrated in the drawings, a current collector that extends in the battery case 11 and is connected to a current collector plate (a current collector foil) of a positive electrode or a negative electrode of an electrode body inside the battery case 11 is provided in the base portion 12b of the internal terminal 12.

<External Terminal 13>

The external terminal 13 is a substantially plate-shaped member mounted outside the lid 11b as a battery case component. The external terminal 13 has an insertion hole 13a and an attachment hole 13b. The insertion hole 13a is a hole through which the shaft 12a of the internal terminal 12 is inserted. The attachment hole 13b is a hole used for attaching the connection terminal 41. An edge of the insertion hole 13a is tapered such that an inner diameter of the insertion hole 13a gradually increases toward an outer surface of the external terminal 13. The attachment hole 13b is provided in a position apart from the insertion hole 13a, and the connection terminal 41 is attached in the attachment hole 13b. The connection terminal 41 includes a flange 41a and a shaft 41b provided so as to erect from the flange 41a herein. The attachment hole 13b is a hole formed such that the flange 41a of the connection terminal 41 does not pass through the attachment hole 13b but the shaft 41b of the connection terminal 41 is inserted through the attachment hole 13b.

<Insulation Members 14>

The insulation member 14 is provided between the lid 11b as a battery case component and the internal terminal 12 and between the lid 11b as a battery case component and the external terminal 13. In this embodiment, the insulation member 14 is formed of the first insulation member 14a and the second insulation member 14b. The first insulation member 14a is mounted between the lid 11b as a battery case component and the internal terminal 12. A boss 14a1 that is an annular projection that is mounted in the attachment hole 11b1 of the lid 11b is provided in the first insulation member 14a. The shaft 12a of the internal terminal 12 is inserted in the boss 14a1. The second insulation member 14b is mounted between the lid 11b as a battery case component and the external terminal 13. In this embodiment, the second insulation member 14b is made of resin having desired rigidity. The second insulation member 14b includes an insertion hole 14b1 through which the shaft 12a of the internal terminal 12 is inserted and a cavity 14b2 in which the flange 41a of the connection terminal 41 is arranged. A projection 14b3 that is mounted in the cavity 11b2 in the outer surface of the lid 11b is provided in the second insulation member 14b.

<Assembling Step>

In an assembling step, the lid 11b, the internal terminal 12, the external terminal 13, the insulation member 14, and the connection terminal 41 are assembled. In this embodiment, as illustrated in FIG. 1, the first insulation member 14a is arranged inside the lid 11b, and the boss 14a1 that is an annular projection of the first insulation member 14a is mounted in the attachment hole 11b1 of the lid 11b. The shaft 12a of the internal terminal 12 is inserted through the boss 14a1. Thus, the first insulation member 14a is provided between the lid 11b and the internal terminal 12 to provide insulation between the lid 11b and the internal terminal 12.

The insertion hole 14b1 of the second insulation member 14b is mounted on the shaft 12a of the internal terminal 12 that projects from the attachment hole 11b1 of the lid 11b, and the second insulation member 14b is attached to the outer surface of the lid 11b. At this time, the projection 14b3 of the second insulation member 14b is mounted in the cavity 11b2 in the outer surface of the lid 11b. Thus, the second insulation member 14b is positioned in the outer surface of the lid 11b. The flange 41a of the connection terminal 41 is mounted in the cavity 14b2 of the second insulation member 14b. Furthermore, the attachment hole 13b of the external terminal 13 is mounted on the shaft 41b of the connection terminal 41, and the insertion hole 13a of the external terminal 13 is mounted on the shaft 12a of the internal terminal 12 that projects from the insertion hole 14b1 of the second insulation member 14b. The external terminal 13 is arranged on the second insulation member 14b. As described above, the second insulation member 14b is provided between the lid 11b and the external terminal 13 to provide insulation between the lid 11b and the external terminal 13.

Furthermore, as illustrated in FIG. 1, a tip of the shaft 12a of the internal terminal 12 is pressed and expanded along a peripheral edge portion 13a1 of the insertion hole 13a of the external terminal 13. In this embodiment, an edge of the insertion hole 13a is gradually expanded, so that an inner diameter of the insertion hole 13a increases toward the outer surface of the external terminal 13. The tip of the shaft 12a of the internal terminal 12 is pressed and expanded along the peripheral edge portion 13a1 of the insertion hole 13a having an inner diameter that gradually increases. A portion in which the tip of the shaft 12a of the internal terminal 12 is pressed and expanded will be referred to as a rivet head 12a1 as appropriate. The rivet head 12a1 of the internal terminal 12 overlaps a periphery of the insertion hole 13a of the external terminal 13. As described above, in this embodiment, in the assembling step, a portion of the internal terminal 12 is made to overlap the external terminal 13.

<Welding Step>

In the welding step, the rivet head 12a1 formed by pressing and expanding the tip of the shaft 12a into a disk shape along the peripheral edge portion 13a1 of the insertion hole 13a in a caulking step is irradiated with laser, thereby welding the rivet head 12a1 and the peripheral edge portion 13a1 of the insertion hole 13a. At this time, the internal terminal 12 is at least partially arranged inside the battery. Therefore, a material having desired corrosion resistance is used. For example, in a negative electrode of a lithium-ion secondary battery, copper or a copper alloy is used for the internal terminal 12. In contrast, for the external terminal 13, a lightweight and low-cost material is required. Therefore, aluminum or an aluminum alloy, which is lighter than copper or a copper alloy and is more advantageous in cost, is used. As described above, when copper or a copper alloy is used for the internal terminal 12 and aluminum or an aluminum alloy is used for the external terminal 13, dissimilar metal welding is performed in welding of the internal terminal 12 and the external terminal 13.

In the welding step herein, as illustrated in FIG. 2, the rivet head 12a1 of the internal terminal 12 and the external terminal 13 are welded astride an edge 12a2 of the rivet head 12a1 of the internal terminal 12. In this welding, for example, the rivet head 12a1 of the internal terminal 12 serving as a current collector terminal may be irradiated with laser and thus a welded portion that passes through the internal terminal 12 and reaches the external terminal 13 may be formed. In this embodiment, copper or a copper alloy is used for the internal terminal 12, and aluminum or an aluminum alloy is used for the external terminal 13. Therefore, a melting point of the internal terminal 12 made of copper or a copper alloy is higher than that of the external terminal 13 made of aluminum or an aluminum alloy. When the edge 12a2 of the rivet head 12a1 of the internal terminal 12 is melted by irradiation with laser, the external terminal 13 in touch with a molten pool of melted aluminum or an aluminum alloy is also melted. The molten pool of a melted portion of the internal terminal 12 and a molten pool of a melted portion of the external terminal 13 are mixed together and are solidified, thereby forming a welded portion W.

Note that, in this embodiment, in the welding step, the rivet head 12a1 of the internal terminal 12 and the external terminal 13 are welded astride the edge 12a2 of the rivet head 12a1 of the internal terminal 12. In the welding step, the internal terminal 12 serving as a current collector terminal may be irradiated with laser and a welded portion that passes through the internal terminal 12 and reaches the external terminal 13 may be formed. There is no particular limitation on setting of a welding line in which laser is operated in the welding step, or the like, unless specifically stated otherwise. The welded portion W described above may be provided in a plurality of positions in the edge 12a2 of the rivet head 12a1. Output of laser or the like may be adjusted as appropriate.

The internal terminal 12 made of copper or a copper alloy and the external terminal 13 made of aluminum or an aluminum alloy are melted and then are solidified, thereby forming the welded portion W. In FIG. 2, as schematically illustrated, according to observations of the present inventor, the welded portion W includes an intermetal compound W1 containing copper and aluminum. In the finding of the present inventor, the welded portion W includes several kinds of the intermetal compound W1. According to analysis of the present inventor, the intermetal compound W1 can include several kinds of intermetal compounds, such as, for example, CuAl₂, CuAl, Cu₅Al₄, Cu₃Al₂, Cu₉Al₄, Cu₃Al, or the like, in accordance with composition thereof. For the composition of the intermetal compound W1 included in the welded portion W, for example, a portion including the welded portion W is cut, a cut surface thereof is polished, several positions in the welded portion W are irradiated with an electron beam, an emitted characteristic X-ray is detected by a detector, and thereby, elements included in the welded portion W are specified from the detected X-ray. The element MAP of aluminum and the element MAP of copper in the welded portion W are obtained by the above described method. The composition of the welded portion W can be analyzed from the element MAP of aluminum and the element MAP of copper.

According to the finding of the present inventor, intermetal compounds of several kinds are included in the welded portion W. A kind of each intermetal compound and a resistance value have a correlation. However, when viewing the welded portion W of the internal terminal 12 and the external terminal 13 as a whole, a low-resistance conduction path is formed. Therefore, a ratio of the intermetal compound W1 formed in the welded portion W has only a small influence on a battery resistance. On the other hand, the intermetal compound W1 of copper and aluminum is more vulnerable than a copper simple substance or an aluminum simple substance. Therefore, when the ratio of the intermetal compound W1 in the welded portion W is large, a crack in the welded portion W or like inconvenience occurs and quality of the welded portion W is easily influenced. Therefore, it is desirable to inspect the ratio of the intermetal compound W1 in the welded portion W.

On the other hand, an inspection method in which the ratio of the intermetal compound W1 in the welded portion W is inspected by cutting the welded portion W and observing a cut surface thereof in a manner described above has been proposed. In the method in which the welded portion W is cut and the cut surface thereof is observed, the welded portion W is damaged, and therefore, all of inspection target products cannot be inspected. Also in cross-sectional examination, X-ray CT, or the like, inspection target products are damaged, and therefore, all of the inspection target products cannot be inspected.

In contrast, the present inventor found that, in a portion in which the intermetal compound W1 is exposed at a surface of the welded portion W, the surface of the welded portion W turns grey. According to the finding of the present inventor, there is a tendency that, the larger a size of the intermetal compound W1 in the welded portion W is, the larger an area of a portion in which the intermetal compound W1 is exposed at the surface of the welded portion W becomes.

Based on the above described findings, the present inventor proposes a new inspection method in which quality determination of the welded portion W is performed based on a ratio of an area of the portion in which the intermetal compound W1 is exposed at a surface of the welded portion W in the welded portion W. In this case, nondestructive inspection of the welded portion W is possible. In the inspection method proposed herein, for example, as illustrated in FIG. 1, a surface image of the welded portion W in which the internal terminal 12 and the external terminal 13 are welded is taken by a camera 210. Then, the ratio of the area of the portion in which the intermetal compound W1 is exposed at the surface of the welded portion W may be obtained by a processor 220. As used herein the term “the ratio of the area of the portion in which the intermetal compound W1 is exposed at the surface of the welded portion W” will be referred to as “the ratio of the area of the intermetal compound W1” as appropriated.

<Step of Obtaining Surface Image>

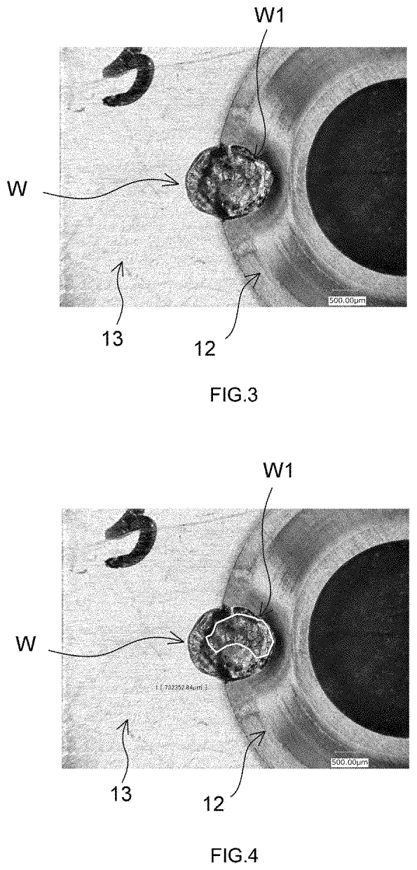

FIG. 3 is a view illustrating a surface image obtained in a step of obtaining a surface image. As illustrated in FIG. 1, the welding quality inspection device 200 includes the camera 210 and the processor 220 herein. The camera 210 may be configured to obtain, for an inspection target object in which the internal terminal 12 and the external terminal 13 are welded, a surface image including the welded portion W in which the internal terminal 12 and the external terminal 13 are welded. Herein, the inspection target object in which the internal terminal 12 and the external terminal 13 are welded may be, for example, a lid assembly in which the internal terminal 12 and the external terminal 13 are assembled to the lid 11b and the internal terminal 12 and the external terminal 13 are welded as described above. For example, the camera 210 may be directed to the welded portion W in which the internal terminal 12 and the external terminal 13 are welded. For example, a distance between the camera 210 and the welded portion W, focus, or the like may be adjusted as appropriate. Note that the inspection target object is not limited to the lid assembly. The inspection target object may be a unit battery as a final product.

In the step of obtaining a surface image, as illustrated in FIG. 1, the surface image of the welded portion W in which the internal terminal 12 and the external terminal 13 are welded is obtained by the camera 210. Specifically, in this embodiment, in the edge 12a2 of the rivet head 12a1 of the internal terminal 12, the surface image of the welded portion W in which the internal terminal 12 and the external terminal 13 are welded may be obtained.

<Step of Obtaining Ratio of Area of Intermetal Compound>

In a step of obtaining a ratio of an area of an intermetal compound, for example, the ratio of the area of the intermetal compound W1 of copper or a copper alloy and aluminum or an aluminum alloy may be obtained from the surface image including the welded portion W, which has been taken by the camera 210. As used herein the term “the area of the intermetal compound” means the area of the portion in which the intermetal compound W1 is exposed at the surface of the welded portion W.

<Image Processing Section 221>

FIG. 4 is a view illustrating an image obtained by extracting the intermetallic compound W1 from the surface image including the welded portion W. As illustrated in FIG. 3, the processor 220 may include an image processing section 221 configured to obtain the ratio of the area of the intermetal compound W1 in an image area including at least the welded portion W, based on the surface image including the welded portion W, which has been taken by the camera 210. As illustrated in FIG. 4, the intermetal compound W1 is extracted from the obtained surface image. As the intermetal compound W1, an intermetal compound of copper or a copper alloy and aluminum or an aluminum alloy may be extracted. In this case, the portion in which the intermetal compound W1 is exposed at the surface of the welded portion W is grey, as compared to other portions, as described above. The portion in which the intermetal compound W1 is exposed at the surface of the welded portion W may be extracted from the surface image including the welded portion W, based on the above described color characteristic, by image processing. Furthermore, only the extracted intermetal compound W1 may be made white or black by binarization processing so as to be distinguished from other areas.

There is a tendency that, the larger the size of the intermetal compound W1 in the welded portion W is, the larger the area of the portion in which the intermetal compound W1 is exposed at the surface of the welded portion W becomes. The ratio of the area of the intermetal compound W1 has a correlation with the size of the intermetal compound W1 in the welded portion W. Note that, as a method in which the ratio of the area of the intermetal compound W1 is obtained from the surface image including the welded portion W, which has been taken by the camera 210, there are several methods.

For example, as illustrated in FIG. 3, the surface image including the welded portion W is obtained by the camera 210 in a size set in advance. A ratio H1 of the area of the intermetal compound W1 in the surface image may be obtained, and thereby, the quality of the welded portion W may be evaluated. In this case, the ratio H1 of the area of the intermetal compound W1 in the surface image is obtained by dividing a pixel number of the extracted intermetal compound W1 by a pixel number of the surface image. The ratio H1 of the area of the intermetal compound W1 in the surface image has a correlation with the size of the intermetal compound W1 in the welded portion W. Therefore, the quality of the welded portion W can be evaluated by obtaining the ratio H1 of the area of the intermetal compound W1 in the surface image. In this case, as the size of the surface image including the welded portion W is closer to the size of the welded portion W, the ratio H1 of the area of the intermetal compound W1 is evaluated to be relatively larger. As the size of the surface image including the welded portion W is closer to the size of the welded portion W, the surface image is more suitable for evaluating the quality of the welded portion W.

Therefore, the image processing section 221 may be configured to define an image area GA having a size set in advance in the surface image so that a ratio H2 of an area of the intermetal compound W1 in the image area GA is obtained, as illustrated in FIG. 5. FIG. 5 is a view illustrating the surface image on which the above described processing of the image processing section 221 has been performed herein.

The ratio H2 of the area of the intermetal compound W1 in the image area GA is obtained as a value highly correlated with the size of the intermetal compound W1 in the welded portion W. In this case, for example, the image area GA having a size set in advance in accordance with the size of the welded portion W may be defined in the surface image. Thus, the ratio H2 of the area of the intermetal compound W1 in the image area GA is closer to the ratio of the area of the intermetal compound W1 in the welded portion W. The quality of the welded portion W can be more properly evaluated by obtaining the ratio H2 of the area of the intermetal compound W1 in the image area GA.

In this embodiment, as illustrated in FIG. 1, the image processing section 221 includes a first processing module 221a and a second processing module 221b.

<First Processing Module 221a>

The first processing module 221a defines the image area GA which includes the welded portion W and has the area set in advance in the surface area (see FIG. 5). For example, the image area GA (see FIG. 5) in the surface image, which includes the welded portion W in which the rivet head 12a1 of the internal terminal 12 and the external terminal 13 are welded and has an area set in advance, may be defined. As the image area GA, for example, as illustrated in FIG. 5, a rectangular image having the area set in advance may be obtained.

<Second Processing Module 221b>

The second processing module 221b extracts the intermetal compound W1 in the image area GA (see FIG. 5). In this embodiment, the second processing module 221b may be configured to extract the portion in which the intermetal compound W1 of copper or a copper alloy and aluminum or an aluminum alloy is exposed at the surface of the welded portion W. Extraction of the portion in which the intermetal compound W1 is exposed at the surface of the welded portion W has been described above, and therefore, will not be described here.

The image processing section 221 may be configured to obtain the ratio H of the area of the intermetal compound W1 extracted by the second processing module 221b in the image area GA defined by the first processing module 221a. The ratio H2 (H2=S2/S1) of the area of the intermetal compound in the image area GA can be obtained, for example, based on a pixel number S1 of the image area GA and a pixel number S2 of the intermetal compound W1, by the above described image processing. As described above, the image processing section 221 may be configured to define the image area GA including at least the welded portion W and obtain the ratio of the area of the intermetal compound W1 in the image area GA.

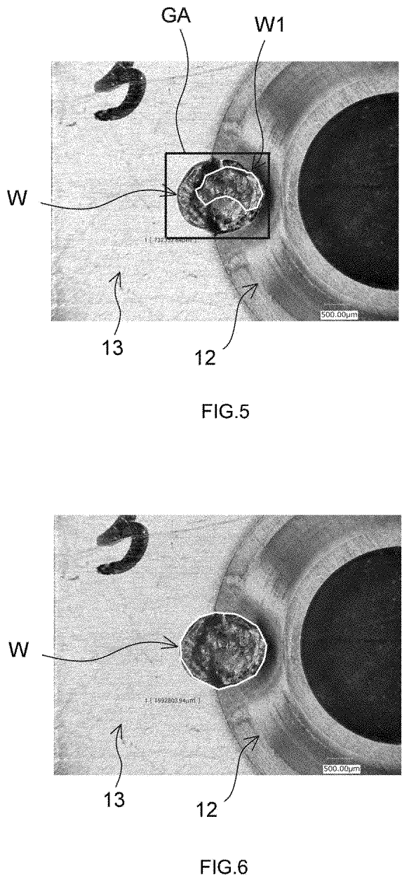

As a method for calculating the ratio of the area of the intermetal compound W1, another embodiment will be described. FIG. 6 is a view illustrating processing of the image processing section 221 in another embodiment. For example, in the surface image including the welded portion W, when a color of the welded portion W can be distinguished from those of other areas, as illustrated in FIG. 6, the welded portion W may be extracted from the surface image and a ratio H3 of the area of the intermetal compound W1 in the welded portion W may be obtained.

In this case, the first processing module 221a may be configured to extract the welded portion W from the surface image, as illustrated in FIG. 6. For example, colors of the rivet head 12a1 of the internal terminal 12 made of copper or a copper alloy, the external terminal 13 made of aluminum or an aluminum alloy, and the welded portion W are different. Based on the above described color difference, a threshold is properly set, and thereby, the welded portion W can be extracted as illustrated in FIG. 5. Furthermore, only the extracted intermetal compound W1 can be made white or black by binarization processing so as to be distinguished from other areas.

The second processing module 221b extracts the portion in which the intermetal compound W1 is exposed at the surface of the welded portion W, as described above. In this case, the image processing section 221 may be configured to obtain the ratio H3 of the area of the intermetal compound W1 extracted by the second processing module 221b in the welded portion W extracted by the first processing module 221a. For example, the ratio H3 (H3=S2/S3) of the area of the intermetal compound in the image area GA can be obtained based on the pixel number S3 of the welded portion W and the pixel number S2 of the intermetal compound W1.

<Evaluation Step>

In an evaluation step, for example, when the ratio of the area of the intermetal compound W1 is lower than a threshold set in advance, the quality of the welded portion W may be determined to be good. The processor 220 includes a determination processing section 222 that embodies the above described quality determination. Various calculation methods can be employed for calculating the ratio of the area of the intermetal compound W1, as described above. Therefore, the threshold used in quality determination for the ratio of the area of the intermetal compound W1 is determined in accordance with an employed method for calculating the ratio of the area of the intermetal compound W1.

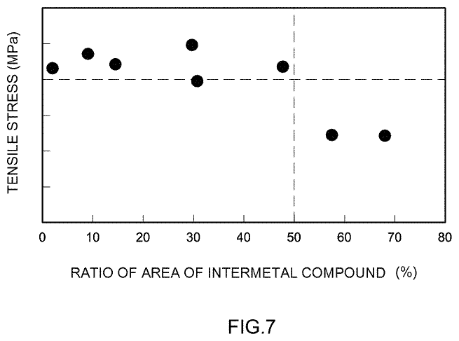

FIG. 7 is a graph illustrating a relationship between the ratio of the area of the intermetallic compound and peeling strength (tensile stress) of the welded portion W of the internal terminal 12 and the external terminal 13. For example, as illustrated in FIG. 7, the relationship between the ratio of the area of the intermetal compound in the image area GA and the peeling strength (tensile stress) of the welded portion W of the internal terminal 12 and the external terminal 13 may be obtained in advance through an examination. In the finding of the present inventor, when the ratio of the area of the intermetal compound in the image area GA is increased to exceed a certain value, the peeling strength of the welded portion W of the internal terminal 12 and the external terminal 13 is reduced. As described above, a threshold may be set in advance for the ratio of the area of the intermetal compound in the image area GA, based on the relationship between the ratio of the area of the intermetal compound in the image area GA and the peeling strength of the welded portion W of the internal terminal 12 and the external terminal 13. For example, in an example illustrated in FIG. 7, when the ratio of the area of the intermetal compound W1 exceeds 50%, the peeling strength (tensile stress) of the welded portion W of the internal terminal 12 and the external terminal 13 is reduced. In the above described case, 50% may be set as the threshold of the ratio of the area of the intermetal compound W1. As described above, a proper threshold is set, and thereby, quality determination for an inspection target object can be performed based on the ratio of the area of the intermetal compound in the image area GA.

The welding quality inspection device 200 may include the camera 210, for example, for a lid assembly assembling step. The camera 210 may be arranged to obtain, for the lid assembly to which the internal terminal 12 and the external terminal 13 are welded, a surface image including the welded portion W in which the internal terminal 12 and the external terminal 13 are welded. In this case, for the lid assembly to which the internal terminal 12 and the external terminal 13 are welded, a surface image including the welded portion W is obtained. The quality of the welded portion W is evaluated from the obtained surface image by processing of the processor 220. In this quality of evaluation, an inspection target object in which the quality of the welded portion W is determined to be not good may be determined to be defective in a stage of assembling the lid assembly, and then, be removed from an assembly line. Thus, eventually, high quality of the battery can be ensured.

As described above, welding of the internal terminal 12 serving as a current collector terminal of the battery, which is made of copper or a copper alloy, and the external terminal 13 of the battery, which is made of aluminum and an aluminum alloy, has been described as an example herein. The welding quality inspection method proposed herein is not limited to welding of the internal terminal 12 and the external terminal 13 of the battery. For example, although not illustrated in the drawings, in a battery pack, the welding quality inspection method can be employed in a similar manner, as appropriated, in dissimilar metal welding in the external terminal of the battery and a bus bar. Dissimilar metal welding is not limited to welding of copper or a copper alloy and aluminum or an aluminum alloy.

Herein, the welding quality inspection method includes an assembling step, a welding step, a step of obtaining a surface image, and a step of obtaining a ratio of an area of an intermetal compound.

Herein, in the assembling step, a first metal member and a second metal member made of a different metal material from a metal material of the first metal member are made to at least partially overlap each other. In the welding step, a portion in which the first metal member and the second metal member are made to overlap each other is welded by irradiating the first metal member with laser to form a welded portion that passes through the first metal member and reaches the second metal member. In the step of obtaining a surface image, a surface image of the portion in which the first metal member and the second metal member are welded is obtained. In the step of obtaining a ratio of an area of an intermetal compound, a ratio of an area of an intermetal compound of the first metal member and the second metal member in an image area including at least the welded portion is obtained based on the surface image.

In the step of obtaining a ratio of an area of an intermetal compound, for example, the ratio of the area of the intermetal compound of the first metal member and the second metal member in the welded portion may be obtained. As described above, several methods can be employed for calculating the ratio of the area of the intermetal compound of the first metal member and the second metal member. In any method, the ratio of the area of the intermetal compound has a correlation with a size of the intermetal compound in the welded portion and can be used as an index for evaluating quality of welding. In this case, the welding quality inspection method may further include an evaluation step of determining, when the ratio of the area of the intermetal compound is lower than a threshold set in advance, that quality of the welded portion is good. According to the above described welding quality inspection method, for example, all of welded spots of inspection target objects can be inspected without destructing welded spots of the inspection targets.

A welding quality inspection device may include a camera, an image processing section, and a determination processing section. In this case, the camera may be configured to obtain a surface image of an inspection target object in which a first metal member and a second metal member made of a different metal material from a metal material of the first metal member are welded, which includes a welded portion in which the first metal member and the second metal member are welded. The image processing section may be configured to obtain, for example, based on the surface image including the welded portion, which has been taken by the camera, a ratio of an area of an intermetal compound of the first metal member and the second metal member in an image area including at least the welded portion. The determination processing section may be configured to determine, when the ratio of the area of the intermetal compound is lower than a threshold set in advance, that quality of the welded portion is good. According to the above described welding quality inspection device, quality of welding can be determined based on the surface image including the welded portion. Therefore, for example, all of welding spots of inspection target objects can be inspected without destructing the welded spots.

In this case, in the surface image including the welded portion, which has been taken by the camera, a color difference between at least a portion in which the intermetal compound of the first metal member and the second metal member is exposed at the surface of the welded portion and other portions may be found out by performing an examination in advance or the like. The image processing section may be configured such that the portion in which the intermetal compound is exposed at the surface of the welded portion is extracted from the surface image.

The image processing section may include, for example, a first processing module configured to extract an image area including the welded portion and having an area set in advance in the surface image, and a second processing module configured to extract an intermetal compound of copper or a copper alloy and aluminum or an aluminum alloy in the image area. The image processing section may be configured to obtain the ratio of the area of the intermetal compound extracted by the second processing module in the image area extracted by the first processing module.

The first processing module of the image processing section may be configured to extract, when a color difference between at least the welded portion in which the first metal member and the second metal member are welded and other portions is found out in the surface image including the welded portion, which has been taken by the camera. In this case, the image processing section may be configured to obtain the ratio of the area of the intermetal compound extracted by the second processing module in the welded portion extracted by the first processing module.

As described above, the welding quality inspection device 200 is not limited to quality inspection for a welding spot of the internal terminal 12 and the external terminal 13 illustrated in FIG. 1. The welding quality inspection device 200 can be used in a method for inspecting a welding spot of various kinds of dissimilar metals. Various functions of the processor 220, the image processing section 221 or the determination processing section 222 may be configured or programmed to be implemented by a cooperative combination of hardware and a computer that executes predetermined programs.

The welding quality inspection method and the welding quality inspection device disclosed herein have been described above. However, the above described embodiments of the welding quality inspection method and the welding quality inspection device or the like shall not limit the present disclosure, unless specifically stated otherwise.

What is claimed is:

1. A method for welding quality inspection comprising:
assembling a first metal member and a second metal member made of a different metal material from a metal material of the first metal member to at least partially overlap each other;
welding a portion in which the first metal member and the second metal member are made to overlap each other in assembling by irradiating the first metal member with laser to form a welded portion that passes through the first metal member and reaches the second metal member;
obtaining a surface image including the welded portion in which the first metal member and the second metal member are welded; and
obtaining, based on the surface image, a ratio of an area of an intermetal compound of the first metal member and the second metal member in an image area including at least the welded portion.

2. The method according to claim 1,
wherein, obtaining a ratio of an area of an intermetal compound, the ratio of the area of the intermetal compound of the first metal member and the second metal member in the welded portion is obtained based on the surface image.

3. The method according to claim 2,
wherein the first metal member is made of copper or a copper alloy and the second metal member is made of aluminum and aluminum alloy.

4. The method according to claim 1, further comprising:
evaluating, when the ratio of the area of the intermetal compound is lower than a threshold set in advance, that quality of the welded portion is good.

5. The method according to claim 1,
wherein the first metal member is a current collector terminal of a battery, which is made of copper or a copper alloy, and the second metal member is an external terminal of the battery, which is made of aluminum and aluminum alloy.

6. A method for producing a battery, comprising:
the method according to claim 5.

7. A welding quality inspection device comprising:
a camera configured to obtain a surface image of an inspection target object in which a first metal member and a second metal member made of a different metal material from a metal material of the first metal member are welded, the surface image including a welded portion in which the first metal member and the second metal member are welded;
an image processing section configured to obtain, based on the surface image including the welded portion, which has been taken by the camera, a ratio of an area of an intermetal compound of the first metal member and the second metal member in an image area including at least the welded portion; and
a determination processing section configured to determine, when the ratio of the area of the intermetal compound is lower than a threshold set in advance, that quality of the welded portion is good.

8. The welding quality inspection device according to claim 7,
wherein the image processing section includes
a first processing module configured to define an image area including the welded portion and having an area set in advance in the surface image, and
a second processing module configured to extract the intermetal compound of the first metal member and the second metal member in the image area, and
is configured to obtain the ratio of the area of the intermetal compound extracted by the second processing module in the image area defined by the first processing module.

9. The welding quality inspection device according to claim 7,
wherein the image processing section includes
a first processing module configured to extract the welded portion in the surface image, and
a second processing module configured to extract the intermetal compound of the first metal member and the second metal member in the welded portion, and
is configured to obtain a ratio of an area of the intermetal compound extracted by the second module in the welded portion extracted by the first processing module.

10. A welding quality inspection device comprising:
a camera configured to obtain, for an inspection target object in which a current collector terminal of a battery, which is made of copper or a copper alloy, and an external terminal of the battery, which is made of aluminum or an aluminum alloy, are welded, a surface image including a welded portion in which the current collector terminal and the external terminal are welded;
an image processing section configured to obtain, based on the surface image including the welded portion, which has been taken by the camera, a ratio of an area of an intermetal compound of the copper or the copper alloy and the aluminum or the aluminum alloy in an image area including at least the welded portion; and
a determination processing section configured to determine, when the ratio of the intermetal compound is lower than a threshold set in advance, that quality of the welded portion is good.

11. The welding quality inspection device according to claim 10,
wherein the image processing section includes
a first processing module configured to extract an image area including the welded portion and having an area set in advance in the surface image, and
a second processing module configured to extract an intermetal compound of the copper or the copper alloy and the aluminum or the aluminum alloy in the image area, and
is configured to obtain a ratio of an area of the intermetal compound extracted by the second module in the image area extracted by the first module.

12. The welding quality inspection device according to claim 10,
wherein the image processing section includes
a first processing module configured to extract the welded portion in the surface image, and
a second processing module configured to extract the intermetal compound of the copper or the copper alloy and the aluminum or the aluminum alloy in the welded portion, and
is configured to obtain a ratio of an area of the intermetal compound extracted by the second module in the welded portion extracted by the first processing module.
